(19) United States
(12) Patent Application Publication
(10) Pub. No.: US 2014/0089999 A1
(43) Pub. Date: Mar. 27, 2014

(54) METHOD FOR VIEWING VIDEO AND AUDIO CLIPS ON A WEBSITE

(71) Applicant: Payam Moradian, Los Angeles, CA (US)

(72) Inventor: Payam Moradian, Los Angeles, CA (US)

(21) Appl. No.: 13/623,876

(22) Filed: Sep. 21, 2012

(51) Int. Cl. H04N 21/25

(52) U.S. Cl. 725/97

(57) ABSTRACT

Provides is a computer implemented method for viewing video and audio clips on a website.

### BACKGROUND OF THE INVENTION

The internet has changed the way people listen to audio or view videos. Websites like YouTube™ provide a plurality of video files that are stored on a server controlled by YouTube. A user can access YouTube and view the videos the user desires by first searching for the video and then viewing the video while the video is stored on YouTube's server.

A problem with viewing videos on YouTube and other similar websites is that a user has to select and view each video individually. This experience is much different than a television where a user can enjoy a video without constantly searching and adding videos for viewing. For example, when viewing music videos on YouTube, each video is typically 3 to 4 minutes long. After a video finishes, the user has to look and find another video. The viewing of multiple videos results in a frustrating experience where a user has to constantly search for a new video after a previous video has finished.

To solve this problem, YouTube provides a playlist for videos where a user selects the videos beforehand and they are put in a list to be played one after another. This playlist experience is still not the same as traditional television. The playlist is made up of individual discreet files and cannot for example be forwarded and rewound from one music video to another like a traditional music video on a DVD. There is a need in the art to provide an experience more resembling that of watching television than discreet videos on a website.

### SUMMARY OF THE INVENTION

In one embodiment, provided is a computer implemented method for watching video on a website having a plurality of videos comprising: a) accessing a website having a plurality of video clips for viewing; b) selecting two or more of the video clips for viewing without downloading any video clip; c) combining the video clips into a single discreet second video clip; d) viewing the second discreet video clip. The video clips can be selected by first performing a search of the plurality of the video clips. The method can further comprise inserting an advertisement in the second discreet video clip. The advertisement can be inserted in between some or all of the video clips that are combined. The second discreet video clip can be played, stopped, rewound, or fast forwarded. The website can delete the second discreet video clip after a user views the clip. The website can store the second discreet video clip after a user views the clip. The website can create a searchable library of a plurality of stored second discreet video clips. The clips that are combined can be each less than about 30 minutes in length.

In another embodiment, provided is a computer implemented method for watching video on a website having a plurality of videos comprising: the website selecting two or more of the video clips for viewing; the website combining the video clips into a single discreet second video clip; the website recommending the second discreet video clip or placing the clip in a searchable library.

In another embodiment, provided is a website accessible through a communication network comprising: a) a search engine; b) a user interface; c) program for combining video clips; d) video player; e) optional user account; and f) storage of video clips; wherein a user accesses the website having the user interface through a communication network, performs a search for video clips on the website, selects the desired videos from the search, combines the videos into a single video clip, and views the single video clip with the video player.

In another embodiment, provided is a computer system for carrying out any of the above methods.

### BRIEF DESCRIPTION OF THE FIGURES

FIG. 1 illustrates the connection of a user with a computing device to a server hosting a website containing videos/audios through a communication network.

FIG. 2 illustrates a website having with a storage of a plurality of video and audio files.

FIG. 3 illustrates a page of the website with the results of a search.

FIG. 4 illustrates a single clip or file that is formed by combining smaller video clips or files.

FIG. 5 illustrates a flow chart explaining the different steps of using a website with the feature of combining smaller clips or files.

### DETAILED DESCRIPTION OF THE INVENTION

The present invention allows a user who views video or listens to audio files on a website (8) combine two or more selected files. By combining multiple files, a user can have the same experience of watching television. The user for example can fast forward and rewind the file to any desired location. If a user selects a sufficient number of videos, the user can for example make a clip that is a few hours long, allowing for a viewing of a single file or clip with the option to forward and rewind, and without any interruption in between. The use of a single clip also diminishes the slight pause that occurs when playing clips on a play list. The user does not download any video from the website and combines the videos and watches them all from the website's servers on a cloud site.

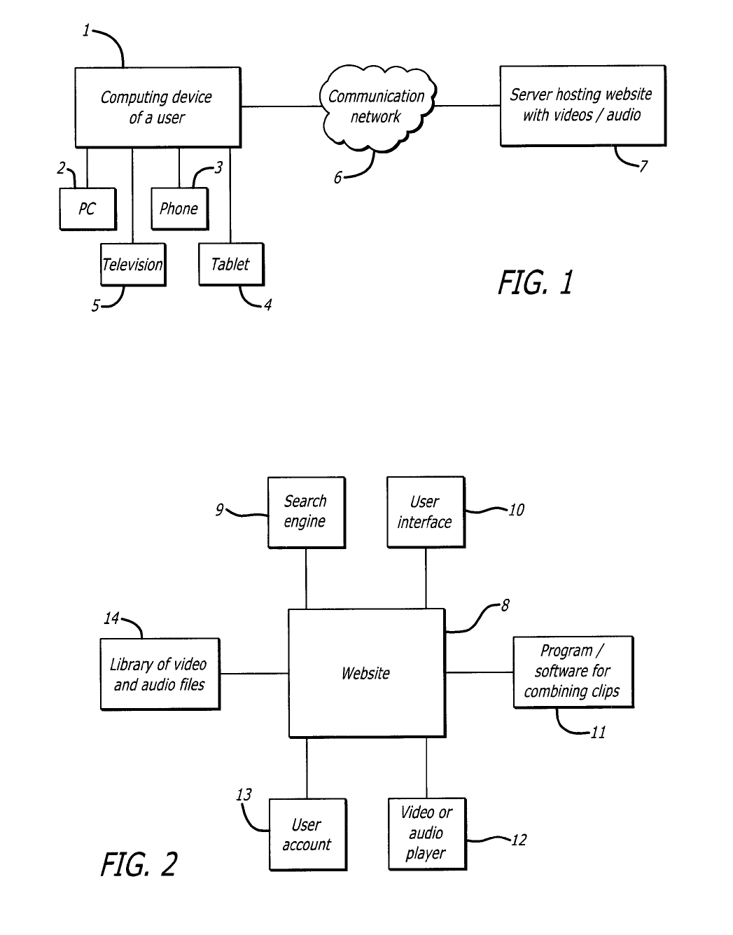

FIG. 1 shows a user connected to a communication network (6). The user may be watching TV (5) that is connected to an internet connection. Or the user may be using a computing device (1) such as a desktop computer (2), laptop computer (2), tablet computer (4), or mobile phone (3). A smart TV (5) is also a computing device. The communication network (6), such as the internet or wireless telephone network, satellite or microwave, allows a user to connect to a server (7) which hosts a website (8) having a storage (14) plurality of video and/or audio clips. The storage can be on one or more servers.

FIG. 2 shows a website having two or more video clips. The website has a storage with a plurality of video clips (14). The website can have a search engine (9) where a user can search for particular videos. The website also has a program or software (11) for executing instructions to combine the different clips or files into one clip or file. The website can have a graphic user interface. (10). The website can also have a video player to play videos. (12). The website can also have an optional user account (13), which allows for logging in and personalizing a viewing experience.

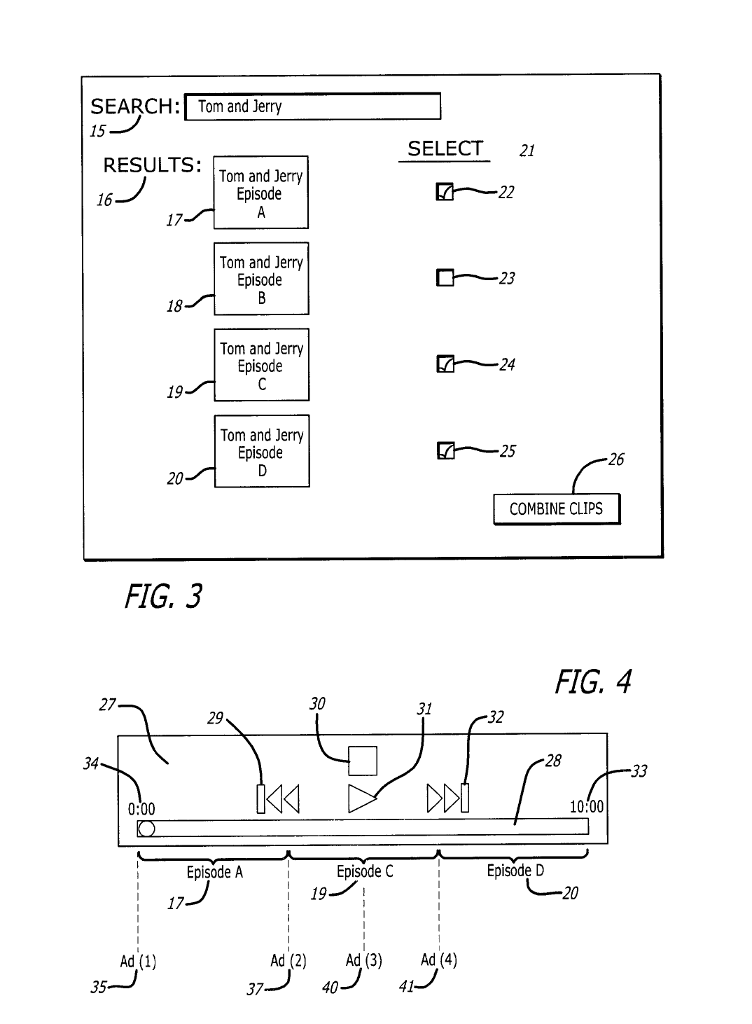

FIG. 3 shows a user searching for videos of the cartoon, Tom and Jerry. A search (15) results in four clips of cartoons (17, 18, 19, and 20), which are presented as discrete videos. A user then selects the videos. (22, 24, 25). Afterwards, the user selects a button (26) which allows for combining the selected clips.

FIG. 4 shows the combined files or clip of the Tom and Jerry videos of FIG. 3. In FIG. 4, the video clip (28) has episode A (17), episode C (19), and episode D (20). Despite containing three episodes, the video clip or file is a single discrete file or clip (28). This newly formed file can be played (31), stopped (30), fast forwarded (32), and rewound (29). These actions can also be done without pressing the buttons, and instead selecting the appropriate section of the clip (28). The hypothetical video clip (28) in FIG. 4 is 10 minutes long (33, 34). When this video clip is formed, advertisement (35, 37, 40, 41) can be inserted at any portion of the clip. For example, advertisement can be inserted at the beginning of the clip, at time zero (34). Alternatively advertisement can be inserted in between each clip (37, 41). Or, advertisement is inserted based on the length of the clip (40), such as at every 5 min. interval, without any consideration as to when and episode begins. Inserting advertisement in the middle of a clip may require first splitting the clip. The advertisement in the beginning (34) can be separate from the clip so the advertisement can be changed (not illustrated) every time the clip is played.

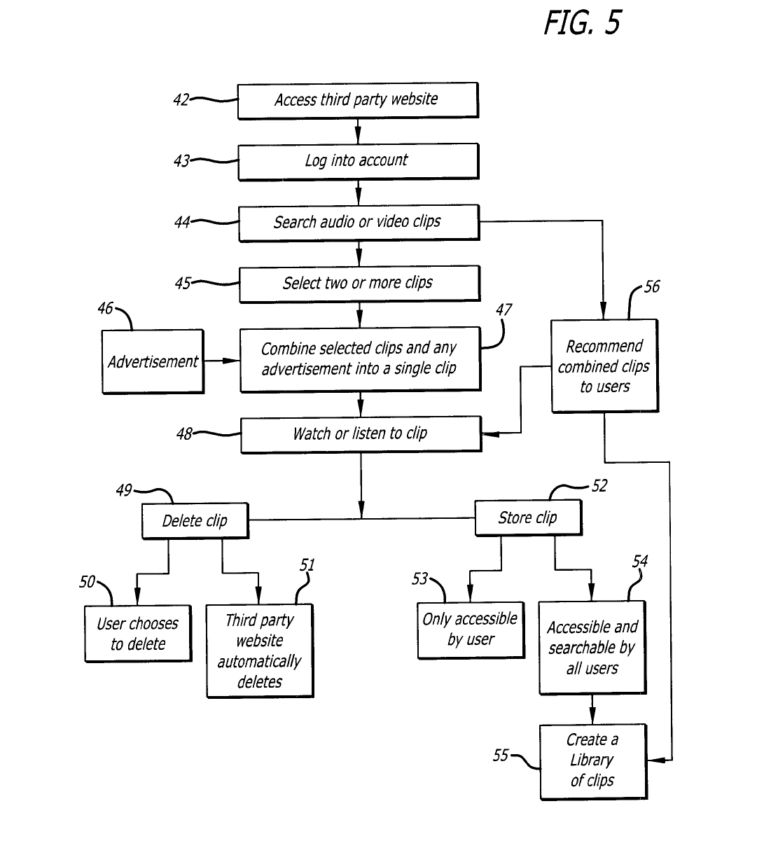

FIG. 5 shows a flowchart from the step of accessing a website to the step of to the step of creating a library (55). A user accesses the third-party website (42) through a communication network (6) as described above. If the user has an account, the user can optionally log into the account (43). The user can then search for audio or video clips (44). Searching also encompasses simple browsing. The user then selects two or more of these clips (45) to be combined into a single clip or file (47). Advertisement (46) can also be inserted into the clip. The user can then watch the clip as a single discrete unit (48), and play, stop, fast-forward, or rewind from one portion of the clip to another despite the clip being formed by combining smaller discrete clips. After a user watches the clip, the system of the website can either delete (49) or store the clip (52). In case of deletion, a user may be given the option to delete the clip (49) or alternatively the website automatically deletes clips (51) after a user finishes viewing the clip and/or logs off. The website can also store the clips (52), either automatically or at the request of the user. The clips that are stored can be stored in such way that only a user with a particular account can have access (53) or the clips can be stored for public access by any user (54). The storing of multiple clips can create its own library (55) of clips that is searchable by users. Alternatively, the website can recommend combined clips (56) to a user and create a library of such combined clips (55). The recommendation of clips can also be used based on user feedback and ratings. The relevant clips can be recommended based on the words a user uses to search for a clip.

The video clips that are combined can be videos of any length or topic. Particularly videos of short length such as less than about 30, or about 20 or about 10 minutes will reap the most benefit from being combined into a larger clip or file. The types of videos can include music videos, cartoons, sports clips, highlight videos, news, documentaries, and short stories. The types of video formats can include wmv, avi, mpg, and dvix.

1. A computer implemented method for watching video on a website having a plurality of videos comprising:
a) accessing a website having a plurality of video clips for viewing;
b) entering a search term;
c) in response to the search term, the website recommending a single discreet video clip comprised of two or more video clips that have been combined; and
d) selecting and viewing the discreet video clip.

2. (canceled)

3. The computer implemented method of claim 1, further comprising the website inserting an advertisement in the second discreet video clip.

4. The computer implemented method of claim 3, wherein the advertisement is inserted in between some or all of the video clips that are combined.

5. The computer implemented method of claim 1, wherein the discreet video clip can be played, stopped, rewound, or fast forwarded.

6. The computer implemented method of claim 1, wherein the website deletes the discreet video clip after a user views the clip.

7. The computer implemented method of claim 1, wherein the website stores the discreet video clip after a user views the clip.

8. The computer implemented method of claim 1, wherein the website creates a searchable library of a plurality of stored discreet video clips.

9. The computer implemented method of claim 1, wherein the clips that are combined are each less than about 30 minutes in length.

10. A computer implemented method for watching video on a website having a plurality of videos comprising:
a) the website selecting two or more of the video clips for viewing;
c) the website combining the video clips into a single discreet second video clip;
d) upon entering of a search term by a user, the website recommending the second discreet video clip.

11. A website accessible through a communication network comprising:
a) a search engine;
b) a user interface;
c) program for combining video clips;
d) video player;
e) optional user account; and
f) storage of video clips;
wherein a user accesses the website having the user interface through a communication network, performs a search for video dips on the website, selects the desired videos from the search, combines the videos into a single video clip without downloading any video, and views the single video clip with the video player; wherein upon entering of a search term by a user, the website recommends a discreet video clip that has been made by combining a plurality of video clips.

12. A computer system for carrying out the method of claim 1.

13. A computer system for carrying out the method of claim 10.

14. The computer implemented method of claim 1, wherein the recommendation is based on user feedback.

15. The computer implemented method of claim 1, wherein the recommendation is based on a recommendation by a user.

16. The computer implemented method of claim 10, wherein the recommendation is based on user feedback.

17. The computer implemented method of claim 10, wherein the recommendation is based on a recommendation by a user.

18. The website of claim 11, wherein the recommendation is based on user feedback.

19. The website of claim 11, wherein the recommendation is based on recommendation by it user.
